(19) United States
(12) Patent Application Publication
(10) Pub. No.: US 2017/0061978 A1
(43) Pub. Date: Mar. 2, 2017

(54) REAL-TIME METHOD FOR IMPLEMENTING DEEP NEURAL NETWORK BASED SPEECH SEPARATION

(71) Applicant: SHANNON CAMPBELL, (US)

(72) Inventors: YUXUAN WANG, COLUMBUS, OH (US); DELIANG WANG, DUBLIN, OH (US); KE HU, SOUTH SETAUKET, NY (US)

(73) Assignee: SHANNON CAMPBELL

(21) Appl. No.: 14/536,114

(22) Filed: Nov. 7, 2014

(51) Int. Cl. G10L 21/0208

(52) U.S. Cl. CPC G10L 21/0208

(57) ABSTRACT

A method and system for separating noise from speech in real time is provided to improve intelligibility of speech for a variety of communications devices and hearing aids. From a speech signal, a plurality of frame-level features are extracted and form the input to the classifier. The classifier is a deep neural network comprising multiple hidden layers and an output layer with multiple output units. The classifier classifies the speech into a plurality of time-frequency units simultaneously. The classifier output constitutes an estimated ideal binary mask from which a fast gammatone filter bank is used to resynthesize the separated speech into an enhanced speech waveform.

### TECHNICAL FIELD

This invention relates generally to speech separation and more particularly to a real-time method for separating speech signals from non-speech interference using acoustic inputs from a single microphone.

### BACKGROUND

In the amplification and processing of speech and other sound signals, noise is typically, and disadvantageously present. The presence of noise can interfere with the extraction or understanding of a speech signal present.

Some systems have attempted to utilize signal processing techniques to separate out the desired signal from the undesired noise, by either suppressing it or removing it. An early example of such processing systems are audio recording systems to suppress tape hiss, and the like when recording. Many of the early systems were analog in nature. However, as computing power has become more easily available, digital signal processing techniques have been increasingly utilized to improve the quality of audio signals. However, many of these techniques tend to be complex. As such they may call for a large amount of processing power and, or time to implement. As such these techniques may be unusable in a device such as a hearing aid, or equivalent device, due to a time delay caused by processing introduced between the time the signal originates, and the time it is received by a person using the hearing aid. Typically to decrease processing time a larger and more complex computing system may be used. However, such enhanced processing systems tend to be less portable. Accordingly it is desirable to be able to quickly process an audio signal while removing or suppressing noise that may interfere with understanding the speech portion of the signal, without having to substantially increase processor or processing complexity.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present example provides a method and system of deep neural network based speech separation described herein for separating noise from speech in real time to improve intelligibility of speech for a variety of communications devices and hearing aids. From a speech signal containing noise, a plurality of frame-level features are extracted and form the input to the classifier. The classifier is a deep neural network comprising multiple hidden layers and an output layer with multiple output units. The classifier classifies the speech into a plurality of time-frequency units simultaneously. The classifier output constitutes an estimated ideal binary mask from which a fast gammatone filter bank is used to resynthesize the separated speech into an enhanced speech waveform.

### DESCRIPTION OF THE DRAWINGS

The present description will be better understood from the following detailed description read in light of the accompanying drawings, wherein:

FIG. 1 is a drawing of an exemplary cell phone containing a microphone and speaker with the requisite processing capability to perform the process of deep neural network based speech separation described herein.

FIG. 2 is a drawing of an exemplary hearing aid containing a microphone and speaker with the requisite processing capability to perform the process of deep neural network based speech separation described herein.

FIG. 3 is a drawing of an exemplary computer containing a microphone and speaker with the requisite processing capability to perform the process of deep neural network based speech separation described herein.

FIG. 4 is a block diagram of an exemplary system that performs monaural speech separation through multi-output classification.

FIG. 5 is a block diagram of an exemplary system that extracts features from noisy speech.

FIG. 6 is a depiction of a multi-output DNN classifier.

FIG. 7 shows a cochleagram of a speech utterance with 64 filter channels.

FIG. 8 shows the ideal binary mask for the audio signal shown in FIG. 7.

FIG. 9 shows a cochleagram of the speech shown in FIG. 7 mixed with babble noise at −5 dB SNR.

FIG. 10 shows the estimated ideal binary mask for the audio signal of FIG. 9.

FIG. 11 is a tabular comparison of detailed processing times (in seconds) between the sub-band classification method and the methods described herein.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of process steps, or sub processes, for constructing and operating the example. However, the same or equivalent functions and sequences may be accomplished by different examples.

Monaural speech separation refers to separating speech and background noise from a single-microphone recording. It has been a subject of significant amount of research in the last few decades, and has numerous applications in both civilian and military domains. In civilian domains, a successful speech separation system excludes noise interference from speech and enhances speech understanding for hearing impaired listeners as a component in hearing aids or cochlear implants. For normal hearing people, speech separation technology can improve mobile communication, performance of automatic speech recognizers (e.g. Siri), and automatic dialog systems under noisy environments, such as cars and subway trains. In military domains, speech separation will improve voice communication in adverse acoustic environments, such as in cockpits or Humvees. The technology can also benefit veterans with hearing loss due to long exposure to loud sounds in battlefields.

Traditional approaches to separating speech include speech enhancement and model-based methods. Speech enhancement methods assume certain statistical properties of noise, which are often hard to meet in real-world environments. Model based methods utilize statistical models to describe acoustic dynamics and re-estimate source signals (e.g. Hu and Wang, “An iterative model-based approach to co-channel speech separation,” EURASIP journal on Audio, Speech, and Music Processing, Article ID 2013-14, 2013). Such methods typically focus on separating one voice from another voice. While separation results are satisfactory when the models match underlying speakers, these methods do not generalize well to unseen speakers.

Recently, classification based methods have made major progress in improving intelligibility of speech in noise. A major goal of classification is to estimate the ideal binary mask (IBM) since IBM-filtered noisy speech demonstrates dramatic speech intelligibility improvement for both normal hearing and hearing impaired listeners (e.g. D. L. Wang et al. in “Speech intelligibility in background noise with ideal binary time-frequency masking,” J. Acoust. Soc. Am., vol. 125, pp. 2336-2347, 2009.)

The IBM is constructed by using the target signal (such as speech) and noise (see D. L. Wang, “On ideal binary mask as the computational goal of auditory scene analysis,” In Divenyi P. (ed.), Speech Separation by Humans and Machines, pp. 181-197, Kluwer Academic, Norwell Mass., 2005). First, the input signal is filtered to multiple frequency channels (sub-bands), and the signal in each sub-band is then divided into overlapping segments. A short segment (e.g. 20 ms) is called a frame, and the signal within a particular frame and sub-band is called a time-frequency (T-F) unit. The IBM is constructed by comparing the local SNR within each T-F unit to a threshold value. T-F units with SNRs greater than the threshold are labeled 1 and T-F units with SNRs equal to or less than the threshold are labeled 0. This binary matrix essentially labels those T-F units as belonging to speech or noise. Once this classification task is accomplished, then speech re-synthesis occurs with the IBM and the original speech signal, removing those portions of the signal identified as noise. In practice, one must estimate the IBM from noisy speech directly in order to separate the target speech.

In the past, audio classification has been addressed, where a single source is supposed to be present at any time and the input signal is classified into different audio sources at different times (e.g. Dmitri Shmunk, “Neural network classifier for separating audio sources from a monophonic audio signal,” US Patent 20070083365, 2007.) The invention presented herein addresses a different problem aimed to separate temporally overlapping speech and noise.

Sub-band classification is a typical method to estimate the IBM. This method classifies T-F units in different sub-bands independently, i.e. multiple classifiers are trained, one for each sub-band, and each classifier estimates one row of the IBM. Different classifiers have been used in the past, such as Gaussian mixture models by Kim et al. in “An algorithm that improves speech intelligibility in noise for normal-hearing listeners,” J. Acoust. Soc. Am., vol. 126, pp. 1486-1494 in 2009, multilayer perceptrons by Hu and Wang in “A tandem algorithm for pitch estimation and voiced speech segregation,” IEEE Trans. Audio, Speech, Lang. Process., vol. 18, pp. 2067-2079 in 2010, support vector machines by Han and Wang, “A classification based approach to speech segregation,” J. Acoust. Soc. Am., vol. 132, pp. 3475-3483 in 2012, and deep neural networks by Wang and Wang, “Towards scaling up classification-based speech separation,” IEEE Trans. Audio, Speech, Lang. Process., vol. 21, pp. 1381-1390 in 2013 and by Wang and Wang, “Monaural speech filter”, PCT/US2013/034564, 2013.

A major weakness in sub-band (i.e. individual frequency bands) classification methods is the large amount of computation involved since classifier training and testing and feature extraction need to be repeatedly performed in each sub-band. For example, to estimate the IBM with 32 rows, i.e. an input signal is analyzed into 32 sub-bands, raw acoustic features must be extracted for all 32 sub-bands, and the 32 corresponding classifiers must be trained. Sub-band classification in the field typically uses 64 or 128 sub-bands. This is prohibitively expensive when computing resource or time is limited, especially for portable devices such as hearing aids or smart phones. What is needed is a real-time classification method.

In brief, the exemplary method of deep neural network based speech separation described herein consists of a set of conceptually separate processes. The first step comprises a feature extraction stage that operates on the original signal. Multiple features are extracted from each frame, where a frame refers to a small time window of the speech signal. The features are used as input to a trained deep neural network, which outputs a plurality of time-frequency units. The time-frequency units constitute an estimated ideal binary mask. The estimated ideal binary mask is combined with the original signal to resynthesize an enhanced speech waveform.

The method first extracts features from an input noisy speech signal, which may be picked up by a microphone or come from a digital file in a storage device. The features describe spectral patterns on a per-frame basis. Each frame of speech refers to a portion of the signal of some relatively small duration (measured in terms of milliseconds) and the frames typically overlap. From each frame various features are extracted, which include an amplitude modulation spectrogram, mel-frequency cepstral coefficients, and relative spectral perceptual linear predictions. Differences of these features from frame to frame can be computed to capture temporal changes. All extracted features are concatenated to form a vector representing temporal, spectral and cepstral characteristics of speech at each frame.

The extracted features are inputs to a single deep neural network (DNN) that has multiple output units. The DNN learns a high-level discriminative representation of the extracted features, which are used to classify T-F units in multiple sub-bands simultaneously as either speech- or noise-dominant.

In the example described herein of deep neural network based speech separation, the method uniquely estimates the IBM by using only a single classifier, which has outputs corresponding to different sub-bands in the IBM. This classifier structure inherently differs from sub-band classifiers. Instead of filtering the input signal into multiple sub-bands and extracting features from each sub-band, features are extracted from the original input signal directly to estimate an IBM column. This structure drastically reduces computation for feature extraction, classifier training, and classification, by as much as 32 or 64 times (or by a factor of 32 or 64), resulting in real-time classification. The efficiency occurs because the computation originally carried out for all 32 or 64 sub-bands is now carried out only once. In addition, using a single classifier allows us to use data across multiple sub-bands rather than from only one sub-band for classification, potentially capturing sub-band correlations for improved IBM estimation.

DNN is a feed forward neural network with more than one hidden layer. A DNN can be trained using the standard back propagation process. Alternatively, there is a two sub-process procedure where the DNN can be trained by first training each hidden layer as a restricted Boltzmann machine (RBM) followed by a global fine-tuning step that uses the standard back propagation process. Each RBM contains a layer of visible units and a layer of hidden units, where the hidden activations are used as inputs to train the next RBM. The outputs of the DNN can be interpreted as the probabilities indicating how likely T-F units are dominated by speech. As the DNN classifies all the T-F units of a current frame simultaneously, it is much more efficient than traditional sub-band classifiers. In addition, the number of calculations performed within each frame show that speech separation using the trained DNN can take place in real time. In other words, the time taken for feature extraction and classification by the method is less than the duration of the frame shift (i.e. 10 ms in one example).

In the two sub-process training procedure, a DNN is first trained unsupervisedly as a stack of RBMs in a layer-by-layer fashion. In the second sub-process, the weights resulting from training the stack of RBMs are used to initialize the DNN, which is then trained using the standard supervised back propagation process. The DNN training can be improved by using the regularized mean square errors as the cost function. The extracted features used in training are from noisy environments such as multi-talker babble and factory noise.

The outputs of a DNN classifier constitute an estimated IBM. The estimated IBM is combined with the noisy speech to produce a resynthesized signal in which most or some of the noise is removed while the speech remains. The enhanced speech signal is then played via a speaker or stored as a digital signal for other applications.

The invention further adapts an efficient gammatone filter bank implementation (V. Hohmann, “Frequency analysis and synthesis using a gammatone filter bank,” Acta Acustica United with Acustica, vol. 88, pp. 433-442, 2002) to resynthesize enhanced speech. This efficient implementation is important for real-time processing, needed for portable devices. Having summarized the process of deep neural network based speech separation in the paragraphs above, the details of the process and its system implementations will be described in detail in the following paragraphs.

The examples below describe in detail a process of deep neural network based speech separation for extracting an audio signal from undesired noise. Although the present examples are described and illustrated herein as being implemented in a cellular telephone, hearing aid, and computer systems, the systems described are provided as examples and are not limiting. As those skilled in the art will appreciate, the present examples are suitable for application in a variety of different types of audio processing systems.

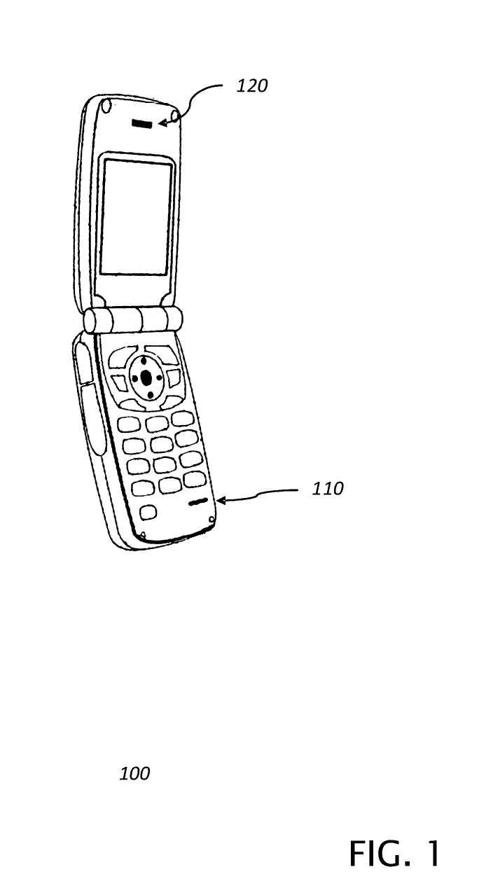

FIG. 1 is a drawing of an exemplary cell phone containing a microphone and speaker with the requisite processing capability to perform the process of deep neural network based speech separation described herein. The cell phone 100 typically includes a speaker 120, and a microphone 110, whose performance in the presence of noise may be improved by including the processing methods described herein in software or firmware (not shown) internal to the cell phone.

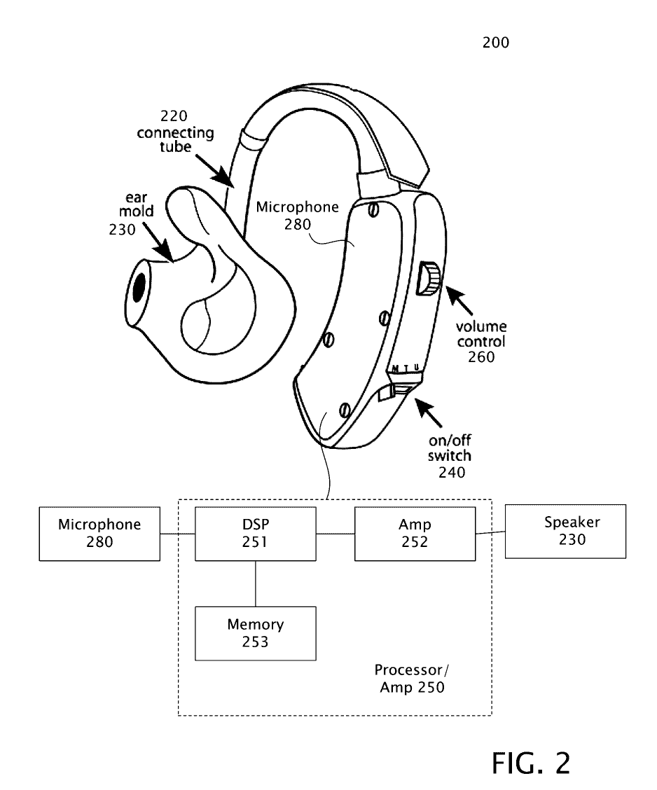

FIG. 2 is a drawing of an exemplary hearing aid 200 a microphone 280 and speaker 230 (which may be contained in an ear mold piece, may have its sound conducted to an ear mold piece, or equivalent) and has the requisite processing capability to perform the process for enhancing the speech signals from background noise; that processing capability is provided in device firmware or software and is typically present in a digital processor/amplifier circuit assembly. Microphones 280 may provide a signal that is processed 250 and transmitted through an audio pick up tube 220 to an ear mold piece with a speaker 230, or equivalent structure to transmit sound into a user's ear. In a hearing aid a volume control 260 may be provided, and a user may also be able to select sound processing options through switch 240 selection. Alternatively selection of signal processing profiles may be selected by the use of computer programming that may be coupled through a wireless link or its equivalent. Hearing aids can be made in many configurations, some more compact than shown. The examples described herein may be applied to any type of hearing aid.

The audio-processing path converts sound received to a signal audible to the user. Typically one or more microphones (typically to improve SNR) 280 are constructed in conjunction with a preamplifier or a final amplifier 252 coupled to the speaker 230. For power efficiency Class D amplifiers, or their equivalents, may often be used in hearing aids due to their low-power operation, low distortion, and small size as compared to more linear Class A or B amplifiers, However, amplifier efficiency is often traded off against signal linearity, and a suitable amplifier class may be selected that provides the desired linearity, and power efficiency. Some hearing aids may also utilize digital signal processing, having a digital signal processor (DSP) 251 and memory circuit 253 that may be inserted in the audio stream before the final amplification so that further processing of the audio input signal may occur to make it more intelligible to the user.

The DSP is where all of the benefits of a digital hearing aid, and in particular the examples of signal processing described herein may be implemented. In general, the DSP may perform signal conditioning operations compression/expansion by band, positive feedback reduction, and the unique speech enhancement as described herein. The DSP may also processes directional information from one or more microphones 280.

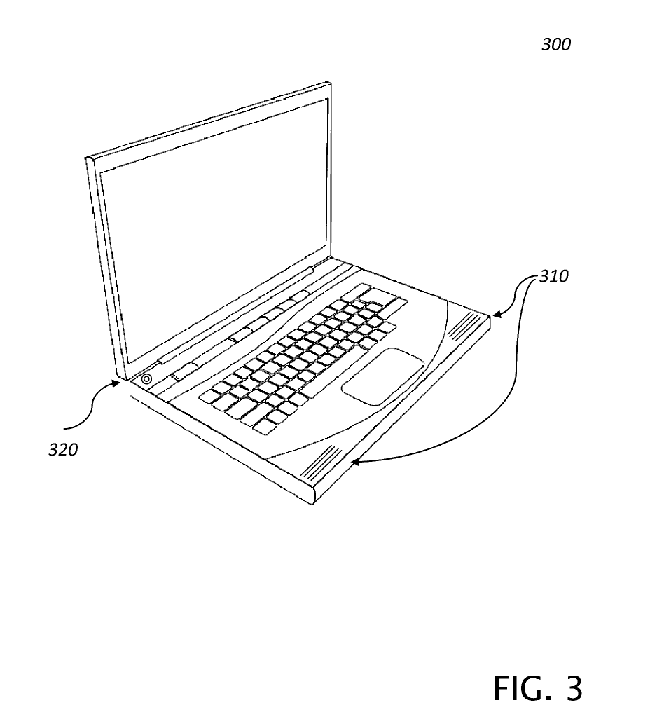

FIG. 3 is a drawing of an exemplary computer 300 containing a microphone 320 and speaker 310 with the requisite internal processing capability to perform the process for extracting an audio signal from background noise. As a further example of the applicability of the examples described herein, application in a laptop computer, tablet, PC, or the like is illustrated. Typically in a computer system such as is shown a DSP would not be provided to process signals as described herein. In a computing device a program executing on a processor in conjunction with a memory (not shown) provides the audio processing to achieve an improved signal that would be output through the speakers 320.

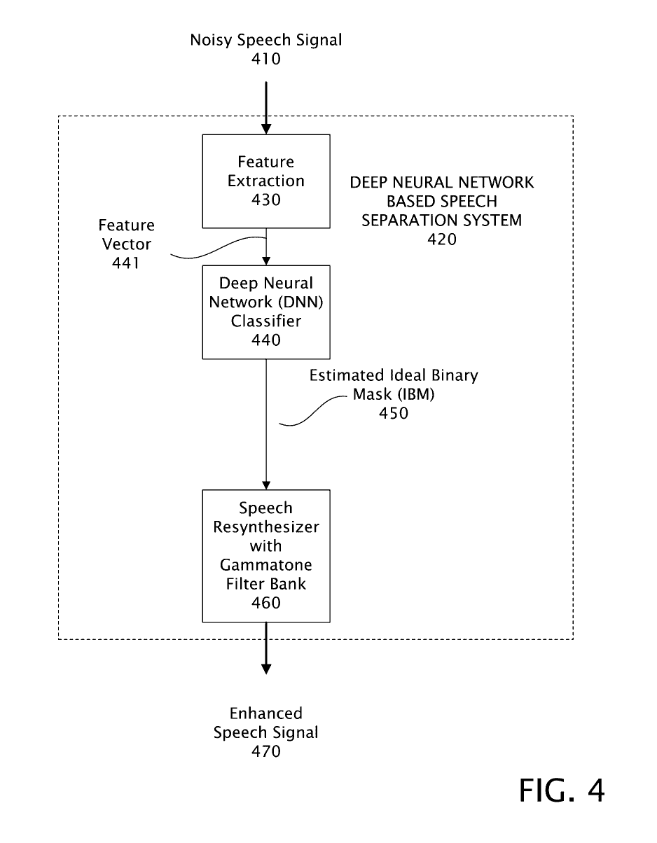

FIG. 4 is a block diagram of an exemplary system that performs monaural speech separation through deep neural network based speech separation or multi-output classification. A speech separation system 420 is shown in which noisy speech 410 is separated into enhanced speech 470. The speech separation system comprises a feature extraction module 430 outputting a feature vector 441 for each frame, a DNN 440 producing an estimated IBM 450, and a speech resynthesized 460. The DNN classifies each T-F for each frame as either signal or noise, which is an IBM, which is then resynthesized. In alternative configurations, the speech separation system may have equivalent modules.

The speech separation system 420 receives a noisy speech 410 which can be a spoken utterance recorded in background noise and digitized by a microphone. The noisy speech 410 can also be read from an audio file already recorded and saved in a digital format.

A feature extraction module 430 receives the noisy speech 410 and then divides it into a plurality of time frames. In each frame, acoustic features are extracted by the feature extraction module to capture temporal and spectral characteristics inherent in speech. The features are designed to represent salient properties of speech robust to noise corruptions. Furthermore, the features extracted may comprise a plurality of types to capture various desired properties. All features are combined to form a vector of a plurality of frame level features for classification in a DNN 440.

The deep neural network (DNN) 440 (i.e. a method and its corresponding computer program) processes the feature vector 441 from the feature extraction module 430. The DNN module comprises a DNN with several hidden layers and an output layer with multiple output units. The outputs of the DNN include an estimated ideal binary mask (IBM) 450. The estimated IBM will be used with the noisy speech signal to resynthesize the output speech in the speech resynthesized module 460.

The speech resynthesized module 460 utilizes a fast gammatone filter bank to resynthesize speech. The output of the speech resynthesized module is an enhanced speech signal with reduced noise 470.

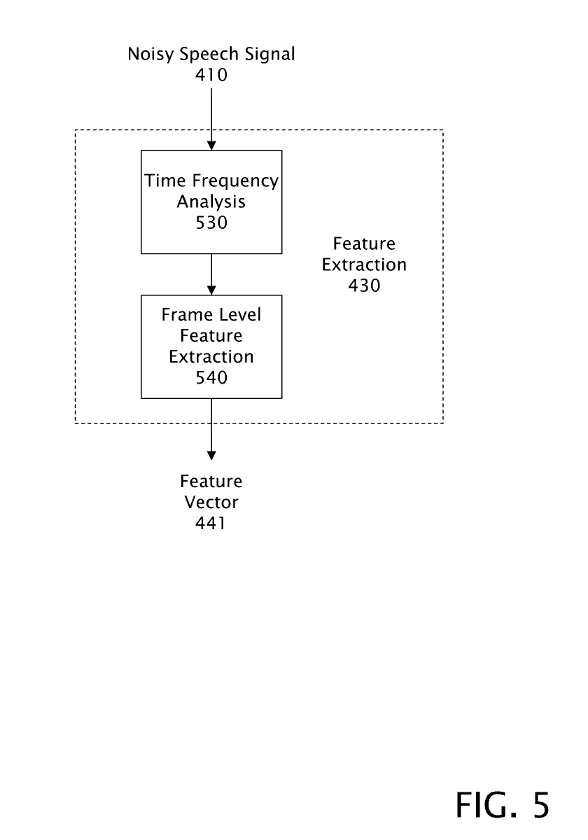

FIG. 5 is a block diagram showing further detail of an exemplary system that extracts features from noisy speech 410. The exemplary feature extraction module 430 is illustrated. The noisy speech 410 is first analyzed by a time-frequency analysis module 530. The noisy speech 410 is divided into a plurality of overlapping frames.

At block 540 frame level feature extraction is performed. For each frame, frequency and related transformations are applied to extract, and produce a compact description of the signal, or feature vector 441. In other words, a set of feature vectors much smaller in bytes than the original noisy speech input signal 410 are produced.

In one example of the invention, a frame length of 20 ms with an overlap of 10 ms is used. Three types of features, i.e. amplitude modulation spectrogram (AMS), mel-frequency cepstral coefficients (MFCC), and relative spectral perceptual linear predictions (RASTA-PLP), are extracted from a noisy speech signal with a sampling frequency of 16 kHz.

To extract AMS features, the noisy speech signal 410 is full-wave rectified and then decimated by a factor of 4. The decimated signal representing the envelope of the noisy speech signal 410 is then divided into 32 ms long segments at the rate of 10 ms. Each segment is then Hanning windowed and transformed by a 256-point fast Fourier transform (FFT) after zero-padding. The FFT magnitudes are multiplied by 15 triangular-shaped windows uniformly centered across 15.6-400 Hz and summed to produce a 15-dimensional AMS vector.

MFCCs are extracted as follows. The noisy speech signal 410 is first pre-emphasized to amplify high frequency energy, and then divided into 20 ms frames, which are Hamming windowed and transformed by a 512-point FFT. The power spectra are then transformed to a perceptual pitch scale called the mel scale, followed by a log operation and discrete cosine transform. The dimensionality of an MFCC vector is 31.

To extract RASTA-PLPs, the power spectrum of each frame of the noisy speech signal 410 is warped to a 20-channel Bark scale (another perceptual scale) using trapezoidal filters. The resulting spectrum is then compressed, filtered by a relative spectral (RASTA) filter, and expanded by an exponential function. Loudness is then adjusted and cepstral coefficients resulting from linear predictions form the RASTA-PLP features. RASTA filtering can be considered as a band pass filter emphasizing speech modulation frequencies while attenuating other lower or higher modulation frequencies. The dimensionality of a RASTA-PLP vector is 13.

For each aforementioned features its deltas (differences) and double deltas (differences of deltas) between neighboring time frames to capture temporal dynamics may be used. All features are then concatenated to form a 177-dimensional feature vector 441. While the feature extraction process is described as being a series of acts that are performed in a sequence, it is understood that some methods may be combined or omitted. For example, the calculation of deltas may be omitted to further speed up feature extraction, and to facilitate real-time processing.

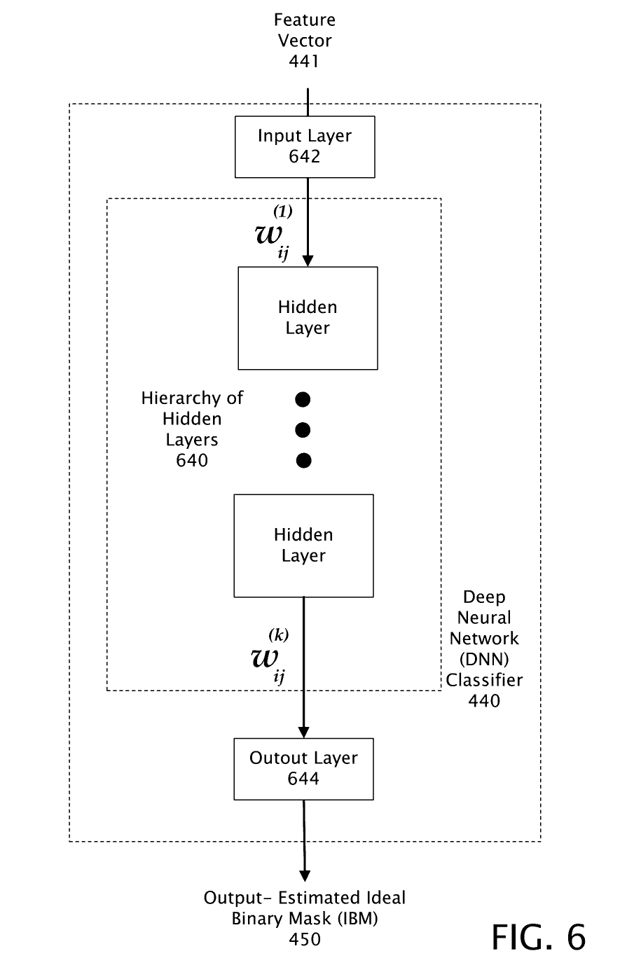

FIG. 6 is a block diagram showing further detail of the multi-output DNN classifier 440. The exemplary deep neural network 440, classifies multiple time frequency (T-F) units as being speech or non-speech. The DNN classifier includes a hierarchy of a plurality of hidden layers 640, an input layer 642 and an output layer 644 which collectively generate multiple output units of an estimated ideal binary mask (IBM) 450. The DNN 440 can be trained using the standard back propagation process. Alternatively, a DNN 440 can be first pre-trained as a stack of restricted Boltzman machines (RBMs), and then fine-tuned by the back propagation process.

An RBM is an undirected graphical model containing a layer of visible units and a layer of hidden units, where the visible and hidden layers are connected by symmetric weights. An RBM is a generative model that models the input data distribution to find statistical patterns (features) therein. The hidden units in the RBM are typically binary units and follow a Bernoulli distribution. The visible units in an RBM can be binary or real-valued (e.g. following a Gaussian distribution), the latter being more suitable for modeling acoustic features.

Training an RBM entails adapting the connection weights by maximizing the probabilities of generating the training data. Therefore, to train the RBM calculation of the gradient of log likelihood is needed. However, exact calculation of the gradient is intractable. A common practice of training the RBM is to approximate the gradient using contrastive divergence (G. Hinton, “Training products of experts by minimizing contrastive divergence,” Neural. Comput., vol. 14, pp. 1771-1800, 2002). Contrastive divergence approximates the gradient as:

$$\frac{\partial ( log p ( {v}_{o} ) )}{\partial {w}_{ij}} \approx {〈 {v}_{i} {h}_{j} 〉}_{data} - {〈 {v}_{i} {h}_{j} 〉}_{reconstruction} \qquad ( 1 )$$

Where vᵢ and hⱼ denote the i-th visible unit and j-th hidden unit. vₒ is a training sample. wᵢⱼ is the symmetric weight connection vᵢ and hⱼ, and < > denotes correlation. The first term in Eq. (1) is the correlation between vᵢ and hⱼ obtained from the training set. The second term, where vᵢ and hⱼ are obtained from network reconstruction can be efficiently calculated by performing one step Gibbs sampling.

The DNN can be considered as a feature detector to find high level patterns from the extracted features. After RBM pre-training, the resulting network weights are used to initialize the DNN, which is then fine-tuned using the back-propagation process where the training labels are provided by the IBM. Typically, a mean squared error or a cross-entropy error between the network outputs and the IBM is used as the objective function for the back-propagation training.

As an example of training a multi-output DNN classifier, the first sub-process uses unlabeled extracted features to perform pre-training of stacked RBMs. In a representative example of this invention, two RBMs may be stacked to form a DNN with two hidden layers. Since acoustic features are typically real-valued vectors, a Gaussian-Bernoulli RBM as the first RBM is used, where the input visible units are Gaussian random variables and hidden units are Bernoulli random variables. As mentioned before, the dimensionality of the input feature vector is 177. Each hidden layer has 50 hidden units, and each unit has a sigmoidal activation function. After RBM pre-training, as the second sub-process the DNN is fine-tuned via the back propagation process using the training labels provided by the IBM. Both the pre-training and fine-tuning are performed using mini-batch stochastic gradient descent.

Turning back to FIG. 4, the trained DNN 440 then outputs speech-dominant T-F units. These outputs comprise an estimated IBM 450, which is used to resynthesize a speech waveform.

The speech resynthesized 460 employs a fast gammatone filter bank implementation for real-time signal analysis and synthesis. Traditionally, a gammatone filter bank is implemented as a set of finite-impulse response (FIR) filters as:

f_{f}_{_{c}}(t)=αt^{N-1}e^{-2πb(f}^{_{c}}^{)t} cos(2πbf_{c}t+φ)u(t) (2)

where t denotes time, f_{c} the center frequency, α a normalization factor, N the filter order, b(f_{c}) the bandwidth, φ the phase, and u(t) the unit step function. Typically the FIR filter has a length of L=2048 samples for signals sampled at 16 kHz. The number of multiplications involved in filtering a length M signal is then ML using direct convolution, which is very expensive. In one implementation, which adapts the implementation described in V. Hohmann, “Frequency analysis and synthesis using a gammatone filter bank,” Acta Acustica United with Acustica, vol. 88, pp. 433-442, 2002, a set of complex-valued filters was derived as follows. The sampled version of the order-N gammatone filter can be written as:

g_{N}[n]=n^{N-1}\tilde{α}ⁿu[n] (3)

Where \tilde{α}=λe^{iβ} and λ is the bandwidth parameter and β the oscillation frequency. Using the following derivations,

$${G}_{1} ( z ) = \frac{1}{1 + \tilde{a} {z}^{- 1}} \\ {G}_{N} ( z ) = - z \frac{d {G}_{N - 1} ( z )}{d z} \qquad ( 4 )$$

The following equation can be derived:

$${G}_{4} ( z ) = \frac{\tilde{a} {z}^{- 1} + 4 {\tilde{a}}^{2} {z}^{- 2} + {\tilde{a}}^{3} {z}^{- 3}}{{( 1 + \tilde{a} {z}^{- 1} )}^{4}} \qquad ( 5 )$$

One can further approximate, the fourth-order gammatone filter, using:

$${K}_{4} ( z ) = {( {G}_{1} ( z ) )}^{4} = \frac{1}{{( 1 + \tilde{a} {z}^{- 1} )}^{4}} \qquad ( 6 )$$

Equation (6) is used in the gammatone filter bank implementation, which dramatically reduces the number of multiplications needed for each sample, thereby enabling real-time synthesis.

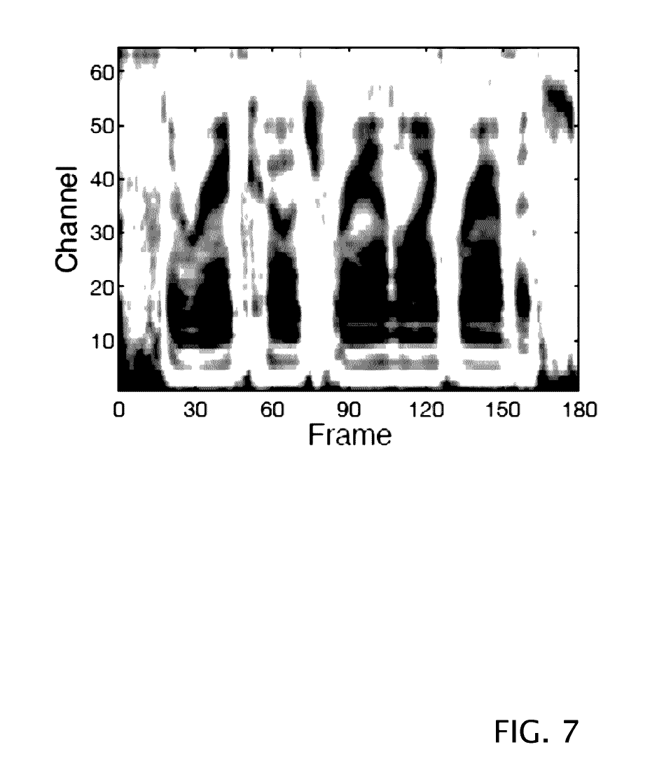

FIG. 7 shows a cochleagram display of a speech utterance with 64 filter channels.

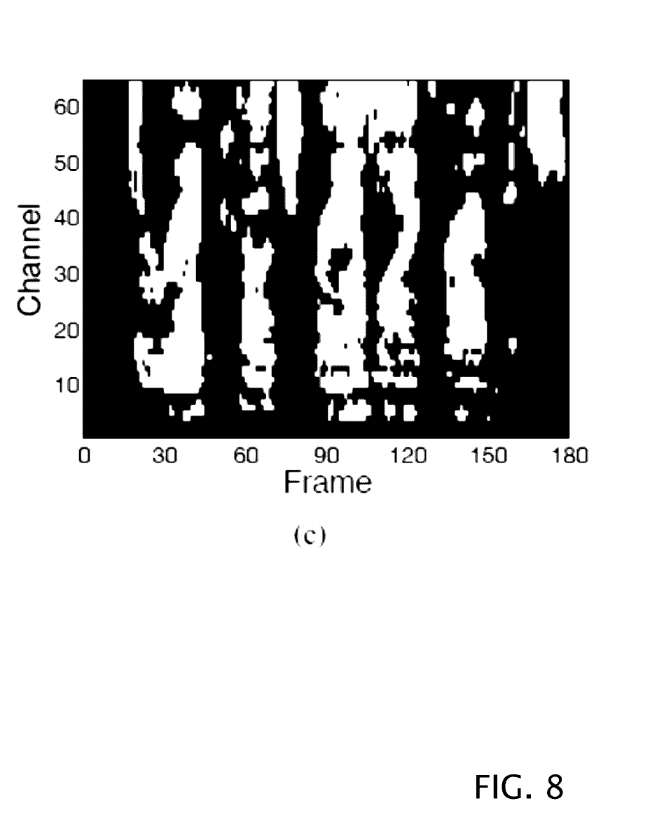

FIG. 8 shows the ideal binary mask for the audio signal shown in FIG. 7.

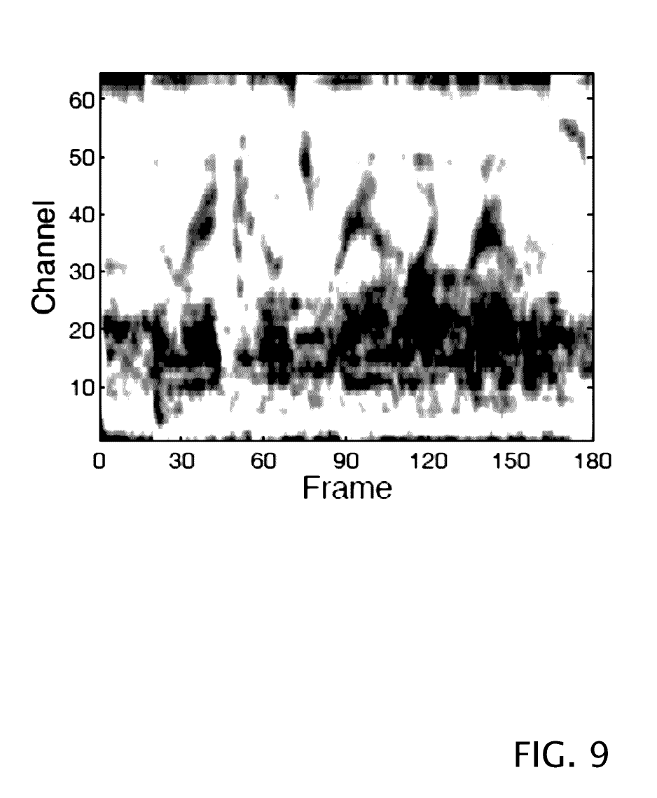

FIG. 9 shows a cochleagram of the speech shown in FIG. 7 with babble noise at −5 dB SNR.

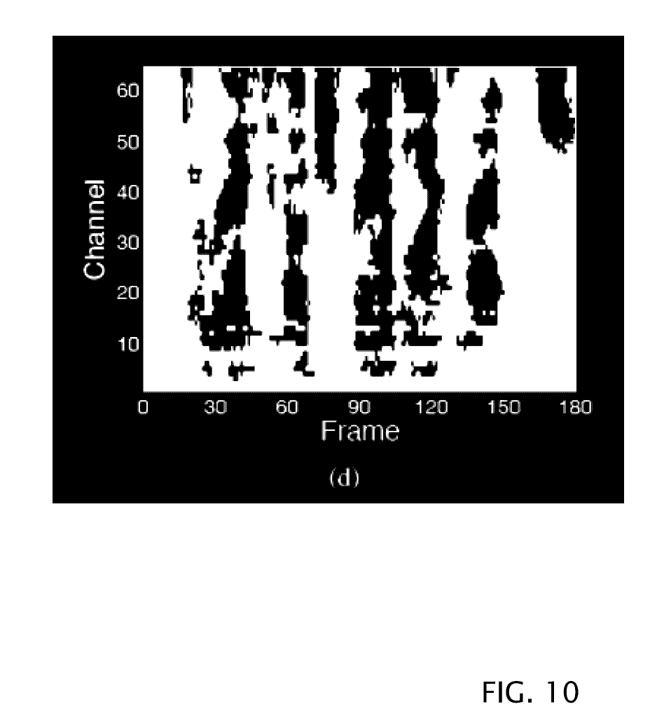

FIG. 10 shows the estimated ideal binary mask for the audio signal of FIG. 9.

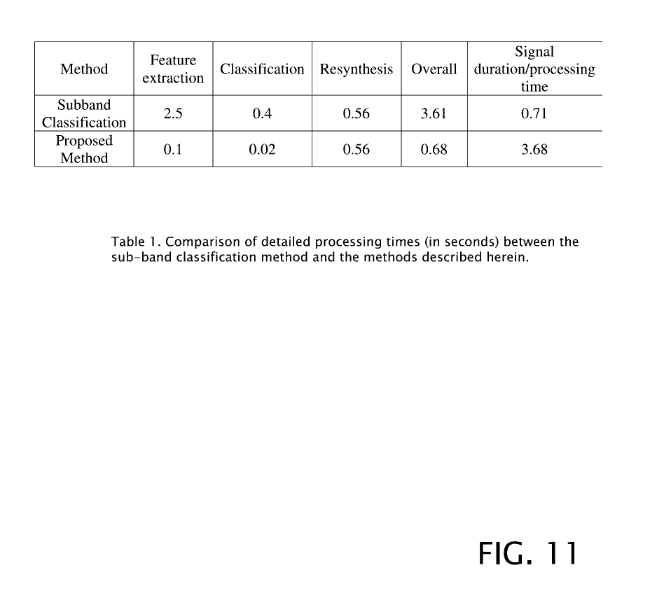

FIG. 11 shows a comparison of detailed processing times (in seconds) between the sub-band classification method and the method in the examples described herein. The processing time of this invention is illustrated in TABLE 1. For a 2.5 s long noisy speech signal, the multiple output classification takes 0.1 s, 0.02 s, and 0.56 s for feature extraction, DNN classification, and re-synthesis, respectively (i.e. 0.68 s in total). The signal length is 3.68 times the processing time of the method. In contrast, the sub-band method takes 3.61 s as also shown in Table 1. Therefore this invention is overall 5.3 times faster than sub-band classification. In terms of feature extraction and classification, the method is 24 times faster. In addition, an analysis of the time complexity of frame-by-frame separation shows that the method takes less than the duration of a frame shift (i.e. 10 ms) to separate the current frame of noisy speech and resynthesize a separated speech waveform. That is, the method has a processing delay that is less than the frame shift, which amounts to real-time processing. The experiments were run in MATLAB on a MacBook Pro laptop with a 2.4 GHz Intel dual-core processor and 4 GB memory.

The systems and methodologies described above generally refer to utilizing a single DNN and frame-level features to predict frame-level IBM vectors. Variants of this system include utilizing frame-level features but training sub-band DNNs to predict the label of each T-F unit. In this case, the output layer of each DNN has only a single output unit. Training must be done for each sub-band but feature extraction is carried out only once. A considerable amount of computation can still be saved in this variant of the system.

Certain aspects of the invention include processing and flows in the form of a process. The processing and flows of the present invention could be implemented in the form of hardware, software, or both. In a preferred example, this invention is implemented in software and takes the form of a computer program product accessible from a computer-readable medium for use by other computer or device or network operating systems. For the purposes of this description, a computer usable or computer readable medium can be any apparatus that may contain, store, communicate, or disseminate the program for use by or in connection with the instruction execution system, apparatus, or device such as a computer-based system, embedded system, or other system that can fetch the instructions from the instruction execution system, apparatus, or device, and execute the instructions.

Those skilled in the art will realize that the process sequences described above may be equivalently performed in multiple orders to achieve a desired result. Also, sub-processes may typically be omitted as desired without taking away from the overall functionality of the processes described above.

1. A real-time method for implementing a deep neural network that separates speech from non-speech interference. The method is executed by a computer system and comprises one or more modules programmed to:
a) receiving noisy speech in an electronic format which includes speech and non-speech interference;
b) extracting features from the received sound and producing frame-level masks (where a frame represents 20 ms of data) using a classifier comprising a deep structure and multiple output units; and
c) using multiple output units to represent an estimated ideal binary mask (time-frequency units classified as speech dominant); and
d) using a fast gammatone filter bank with the estimated ideal binary mask to resynthesize the speech waveform eliminating at least some of the noise.

2. The method of claim 1, wherein the extracted features comprise amplitude modulation spectrogram, mel-frequency cepstral coefficients, and relative spectral perceptual linear predictions and their differences.

3. The method of claim 1, wherein the frame-level masks are vectors containing probabilities of whether a plurality of T-F units are dominated by speech.

4. The method of claim 3, wherein a plurality of time-frequency units comprises time-frequency units at different frequency bands and the time represents some length, or window of time (the frame).

5. The method of claim 1, wherein the deep structure is a deep neural network comprising a stack of restricted Boltzmann machines.

6. The method of claim 5, wherein a restricted Boltzmann machines comprises a layer of visible units and a layer of hidden units, and wherein pre-training of a restricted Boltzmann machines comprises utilizing an unsupervised process to determine weights of connections between layers.

7. The method of claim 5, wherein the deep neural network performs restricted Boltzmann machines pre-training with respect to the deep structure.

8. The method of claim 7, wherein the deep neural network utilizes back propagation to refine the weights between the layers.

9. The method of claim 1, wherein the deep neural network classification output further comprises utilizing a speech re-synthesizer to convert speech dominant time-frequency units into a speech waveform.

10. The method of claim 9, wherein the speech resynthesized further utilizes a fast gammatone filter bank implementation for signal analysis and synthesis.

11. The method of claim 1, in which non-transitory computer-readable storing computer-executable program instructions execute the one or more modules.

12. a system comprising:
a frame level feature extraction block applied to an input speech signal, and outputting a plurality of frame level features;
a classifier block to which the plurality of frame level features is applied, and outputs a plurality of time frequency units which are classified as speech or noise; and
a fast gammatone filter bank to which the plurality of time frequency units is applied, and outputting an enhanced speech signal.

13. The system of claim 12, in which the feature extraction block further comprises:
a time frequency analysis block; and
a frame level feature extraction block.

14. The system of claim 12, in which the classifier block is a deep neural network.

15. The system of claim 12, in which the output of the DNN represents a plurality of time frequency units to form an estimated ideal binary mask.

16. The system of claim 12, in which the classifier block includes a hierarchy of hidden layers.

17. A method of extracting a signal from noise comprising:
dividing the signal containing speech and noise into a plurality of overlapping frames;
extracting acoustic features from each of the plurality of frames to form a vector;
classifying the vector with a deep neural network with multiple outputs;
forming an estimated ideal binary mask; and
resynthesizing the estimated ideal binary mask with a gammatone filter bank to form an enhanced speech output signal.

18. The method of extracting a signal from noise of claim 17 in which the acoustic features are temporal and spectral characteristics inherent in speech robust to noise corruptions.

19. The method of extracting a signal from noise of claim 17, in which the deep neural network includes a plurality of hidden layers, and an output layer with multiple outputs.
